(19) United States
(12) Patent Application Publication
(10) Pub. No.: US 2014/0072886 A1
(43) Pub. Date: Mar. 13, 2014

(54) RECHARGEABLE ELECTROCHEMICAL ZINC-OXYGEN CELLS

(71) Applicant: BASF SE, Ludwigshafen (DE)

(72) Inventors: Tobias URBAN, Bensheim (DE); Thomas Giesenberg, Wachenheim (DE); Eva Mutoro, Ludwigshafen (DE); Sigmar Braeuninger, Hemsbach (DE); Gunter Bechtloff, Heuchelheim (DE)

(73) Assignee: BASF SE, Ludwigshafen (DE)

(21) Appl. No.: 14/012,187

(22) Filed: Aug. 28, 2013

Related U.S. Application Data
(60) Provisional application No. 61/697,839, filed on Sep. 7, 2012.

(51) Int. Cl. H01M 12/08

(52) U.S. Cl. CPC H01M 12/08
USPC 429/406

(57) ABSTRACT

The present invention relates to rechargeable electrochemical zinc-oxygen cells comprising
A) at least one anode comprising metallic zinc,
B) at least one gas diffusion electrode comprising
   (B1) at least one cathode active material, and
   (B2) optionally at least one solid medium through which gas can diffuse, and
C) an aqueous electrolyte comprising boric acid.

The present invention further relates to uses of the inventive rechargeable electrochemical zinc-oxygen cells, to zinc-air batteries comprising the inventive rechargeable electrochemical zinc-oxygen cells, and to the use of an aqueous electrolyte comprising boric acid for production or for operation of rechargeable electrochemical zinc-oxygen cells.

The present invention relates to rechargeable electrochemical zinc-oxygen cells comprising

A) at least one anode comprising metallic zinc,
B) at least one gas diffusion electrode comprising
(B1) at least one cathode active material, and
(B2) optionally at least one solid medium through which gas can diffuse, and
   C) an aqueous electrolyte comprising boric acid.

The present invention further relates to uses of the inventive rechargeable electrochemical zinc-oxygen cells, to zinc-air batteries comprising the inventive rechargeable electrochemical zinc-oxygen cells, and to the use of an aqueous electrolyte comprising boric acid for production or for operation of rechargeable electrochemical zinc-oxygen cells.

Secondary batteries, accumulators or rechargeable batteries are just some embodiments by which electrical energy can be stored after generation and used as required. Owing to the significantly better power density, there has in recent times been a move away from the water-based secondary batteries toward development, especially for the electrical mobility sector, of those batteries in which the charge transport in the electrical cell is accomplished by lithium ions. Nevertheless, alternative water-based secondary batteries are being sought, these being more environmentally friendly compared to the lead accumulators which have long been used and having a higher power density and longer lifetime. An interesting alternative to lead accumulators is that of what are called metal-air batteries, especially zinc-air batteries.

The known metal-air batteries comprise, as essential constituents, a negative electrode, for example zinc, and a positive electrode, which consists preferably of an electronically conductive support material composed of finely divided carbon, to which a catalyst for oxygen reduction is applied. In this context the negative electrode and positive electrode are separated by a separator which may take the form of a membrane. In a customary embodiment, metal, for example zinc, is oxidized with atmospheric oxygen in an alkaline electrolyte to form an oxide or hydroxide. The energy released is utilized electrochemically. Zinc-air batteries currently sold commercially are not rechargeable. However, intensive research is being conducted into rechargeable electrochemical zinc-oxygen cells in which application of an electrical voltage reduces the zinc ions formed in the course of discharge back to zinc and releases oxygen as a result of oxidation of the oxides or hydroxides formed in the course of discharge. Rechargeable electrochemical zinc-oxygen cells can be operated either with aqueous acid electrolytes (WO2012/012558) or with basic electrolytes (WO2007/065899).

The known rechargeable zinc-oxygen cells, however, are still in need of improvement especially with regard to the following properties: performance of the cell, energy efficiency of the cell and cycling stability. In addition, optimization of the costs incurred by material and production expenditure should be taken into account in order to advance the spread of this new energy storage technology.

It is an object of the present invention to provide rechargeable zinc-oxygen cells which constitute an advance over the prior art with regard to at least one of the aforementioned properties. A particularly important feature of the rechargeable zinc-oxygen cells is ultimately the cycling stability, which has to be improved with otherwise comparable properties of the cells.

This object is achieved by a rechargeable electrochemical zinc-oxygen cell defined at the outset, which comprises

A) at least one anode comprising metallic zinc,
B) at least one gas diffusion electrode comprising
(B1) at least one cathode active material, and
(B2) optionally at least one solid medium through which gas can diffuse, and
   C) an aqueous electrolyte comprising boric acid.

### BRIEF DESCRIPTION OF THE DRAWINGS

FIG. 1 and FIG. 2 show photographs of the steel sheets after the zinc deposition in various electrolytes. The current density range applicable is indicated here by the double-headed arrow drawn in.

The anode of the inventive rechargeable electrochemical zinc-oxygen cell, also called anode (A) for short in the context of the present invention, comprises metallic zinc.

The metallic zinc may be in the form of a solid plate, of a layer on a conductor, for example composed of sheet steel or copper, of a sintered porous electrode, or of a metal powder or granules, optionally in sintered form. In a preferred embodiment, the zinc is in the form of a layer on a conductor in a charged inventive electrochemical cell, the layer being obtainable, for example, in the first charging operation of the cell.

The gas diffusion electrode of the inventive rechargeable electrochemical zinc-oxygen cell, also called gas diffusion electrode (B) or cathode (B) for short in the context of the present invention, comprises at least one cathode active material, also called cathode active material (B1) hereinafter for short, and optionally at least one solid medium, also called medium (B2) hereinafter for short, through which gas can diffuse.

The cathode active material (B1) typically comprises at least one catalyst, in the context of the present invention also called catalyst (b1a) for short, the catalyst (b1a) serving as a catalytically active component for reduction of oxygen in the discharging operation and/or for oxygen evolution in the charging operation of the electrochemical zinc-oxygen cell.

In the context of the present invention, suitable catalysts (b1a) are especially mixed oxides, for example cobalt oxides, nickel oxides, iron oxides, chromium oxides, tungsten oxides, and noble metals and noble metal alloys, especially silver. In a preferred embodiment, a catalytic combination of a catalyst which catalyzes the reduction of oxygen and a catalyst which catalyzes the evolution of oxygen, or a bifunctional catalyst according to WO 2007/065899 A1, page 7 line 14 to page 8 line 27, is used. A preferred catalyst which catalyzes both the oxygen oxidation and reduction is La₂O₃. Preferred catalysts for reduction of oxygen are MnO₂, KMnO₄, MnSO₄, SnO₂, Fe₂O₃, Co₃O₄, Co, CoO, Fe, Pt, Pd, Ag₂O, Ag, spinels or perovskites.

In a preferred embodiment of the present invention, in the inventive rechargeable electrochemical zinc-oxygen cell, the cathode active material (B1) comprises at least one catalyst (b1a) selected from the group consisting of La₂O₃, WC, Ce(WO₄)₃, FeAgMo₂O₈, Fe₂(Wo₄)₃, Mn₃O₄, Mn₂O₃, MnO₂, KMnO₄, MnSO₄, SnO₂, Fe₂O₃, Co₃O₄, CoO, IrO₂, Ag₂O, Co, Ni, Fe, Pt, Pd, Ir, Pt_{4.5}Ru₄Ir_{0.5}, Ag, Pd—W, spinels and perovskites.

The cathode active material (B1) comprises, as well as the catalyst (b1a), additionally preferably at least one catalyst support material, in the context of the present invention also called support material (b1b), for short. The support material (b1b) is typically an electronically conductive material, which serves especially for fixing of the catalyst (b1a). The support material (b1b) should preferably have maximum stability toward oxygen and the oxygen compounds formed in the course of the discharging and charging operations. Suitable support materials are, for example, electrically conductive carbonaceous materials as described in WO 2011/161598, page 5 line 1 to page 6 line 26. Also suitable as support materials are nitrogen-doped carbonaceous materials.

As well as the cathode active material (B1), the gas diffusion electrode (B) optionally comprises at least one solid medium, in the context of the present invention also called medium (B2) for short, through which gas can diffuse. In addition, the medium (B2) also fulfills the function of serving as a support for the cathode active material.

In principle, cathode active materials (B1) can also be used without a further porous medium, i.e. a gas-pervious medium, which serves as a base for stabilization and shaping of the cathode active materials (B1) and additionally ensures contact of the support material (b1b) and of the catalyst (b1a) fixed thereon with oxygen. In this case, the support materials (b1b) can be mixed directly with the catalyst (b1a), or the support materials (b1b) can be processed further to give fibers or flat structures and then coated with the catalyst (b1a), forming a porous, self-supporting structure.

In a further embodiment, the support material (b1b), optionally together with the catalyst (b1a), is applied to a gas-pervious solid medium (B2). Such a gas-pervious solid medium (B2) may, for example, be a nonwoven, for example made from carbon fibers, or glass fibers. Further suitable gas-pervious solid media (B2) are especially metal meshes, metal foams, etc. The gas-pervious solid medium serves, as already mentioned, essentially for mechanical stability and shaping, but also improves electrical contacting if it is itself electrically conductive. Further suitable solid media (B2) are mentioned and described in WO 2011/161598, page 4, lines 4 to 40.

In a preferred embodiment of the present invention, in the gas diffusion electrode of the inventive cell, the gas diffusion electrode further comprises a gas-pervious solid medium (B2) on which the cathode active material (B1) is fixed.

As well as the components of the cathode active material (B1), namely the catalyst (b1a) and the preferably at least one support material (b1b), and the solid medium (B2) preferably present, the gas diffusion electrode (B) of the inventive electrochemical cell preferably comprises at least one binder, which is typically an organic polymer as described in detail in WO 2011/161598, page 6 line 28 to page 8 line 15, the binder mentioned therein being polymer (C) or binder (C). The binder serves principally for mechanical stabilization of the cathode active material (B1), by virtue of bonding of particles of the support material (b1b) and/or of the catalysts (b1a) to one another by the binder, and also results in the cathode active material having sufficient adhesion on a solid medium (B2) or an output conductor. The binder is preferably chemically inert with respect to the chemicals with which it comes into contact in the electrochemical cell.

Cathode (B) may be configured in various forms, for example in a rod shape, in the form of round, elliptical or square columns, or in a cuboidal shape, more particularly also as a flat electrode. For instance, it is possible, in the case that the solid medium (B2) is selected from metal meshes, that the form of the cathode (B) is defined essentially by the form of the metal grid.

In the context of the present invention, the expression “flat” means that one of the three spatial dimensions (extents) of the electrode, a three-dimensional body, namely the layer thickness, is smaller than the two other dimensions, the length and the width. Typically, the layer thickness of the flat electrode is less than the second greatest extent at least by a factor of 5, preferably at least by a factor of 10, more preferably at least by a factor of 20.

In the inventive rechargeable electrochemical zinc-oxygen cell, in the course of the discharging operation thereof, oxygen is reduced at the cathode (A), more specifically molecular oxygen (O₂). Molecular oxygen (O₂) can be used in dilute form, as, for example, in air, or in highly concentrated form.

Inventive rechargeable electrochemical zinc-oxygen cells further comprise an aqueous electrolyte, in the context of the present invention also called electrolyte (C) for short, this electrolyte (C) comprising boric acid. The aqueous electrolyte enables charge transport within the cell between the two electrodes through the migration of ions, and serves as a store for the anode material going into solution during the discharging operation, i.e. as a store for zinc ions.

The boric acid present in the electrolyte (C) serves for buffering of a desired pH or pH range. In principle, inventive rechargeable electrochemical zinc-oxygen cells can be operated within a wide pH range.

The amount of boric acid in the electrolyte (C) can be varied within a wide range and depends both on the desired buffer capacity and on the solubility of the boric acid in the electrolyte. Preference is given to using the boric acid (B(OH)₃) in the aqueous electrolyte in a concentration of 0.1 to 50 g/l, preferably of 1 to 35 g/l, more preferably 10 to 30 g/l, especially 20 to 25 g/l.

The charge transport within the cell is brought about by what are called conductive salts which have good water solubility and whose ions do not cause any unwanted side reactions during the operation of the inventive rechargeable electrochemical zinc-oxygen cell. As well as the inevitably present water-soluble zinc salts, the further conductive salts used are preferably also salts of alkali metals or ammonium salts, especially salts of alkali metals.

Examples of suitable zinc salts are zinc halides, such as zinc chloride, zinc bromide or zinc iodide, especially zinc chloride, and zinc sulfate or zinc methanesulfonate.

Examples of suitable salts of alkali metals are halides, preferably chlorides, bromides or iodides, especially chlorides, sulfates or methanesulfonates of the alkali metals lithium, sodium, potassium, rubidium or cesium, preferably of sodium or potassium.

In one embodiment of the present invention, in the inventive rechargeable electrochemical zinc-oxygen cell, the aqueous electrolyte comprises at least one conductive salt selected from the group of salts consisting of alkali metal halides, alkali metal sulfates, alkali metal methanesulfonates, zinc halides, zinc sulfate and zinc methanesulfonate. Preferred conductive salts are selected from the group consisting of sodium chloride, potassium chloride, sodium sulfate, potassium sulfate, sodium methanesulfonate, potassium methanesulfonate, zinc chloride, zinc sulfate and zinc methanesulfonate, more preferably selected from the group of salts consisting of potassium chloride, potassium sulfate, zinc chloride and zinc sulfate.

In the electrolyte (C), the concentration of the zinc salt used may be varied within a wide range. In general, the amount of Zn²⁺ ions in the electrolyte (C) is within a range from at least 0.1 g/l up to the saturation concentration of the respective zinc salts, preferably within a range from 1 g/l 40 to 100 g/l, especially in the range from 2.5 g/l to 25 g/l. During the charging operation of the rechargeable electrochemical zinc-oxygen cell, the amount of Zn²⁺ ions in the electrolyte (C) decreases, and correspondingly increases in the discharging operation.

The concentration of the further conductive salts used in addition to the zinc salt(s) used, especially the abovementioned sodium or potassium salts, in the electrolyte (C) may likewise be varied within a wide range. An upper limit is imposed particularly by the avoidance of precipitation of any salts.

In the case of a chloride-containing electrolyte comprising zinc chloride and sodium chloride and/or potassium chloride, preference is given to establishing a molar ratio of Zn²⁺ ions to Cl⁻ ions in the range from 1:2 to 1:30, preferably in the range from 1:5.5 to 1:14.8, especially in the range from 1:8.3 to 1:9.2, by adding the appropriate amounts of chloride, for example in the form of alkali metal chloride or else hydrogen chloride.

In a further embodiment of the present invention, in the inventive rechargeable electrochemical zinc-oxygen cell, the aqueous electrolyte has a pH in the range from 0 to 7, preferably in the range from 2 to 6.

The setting of the desired pH in the electrolytes to a pH within the range between 0 and 7 is preferably undertaken by addition of a Brønsted acid as a proton donor to the electrolyte (C). Useful Brønsted acids preferably include the acids corresponding to the anions present in the electrolyte (C), i.e. aqueous solutions of hydrogen halides, especially hydrochloric acid, sulfuric acid or methanesulfonic acid. Particular preference is given to using hydrochloric acid or sulfuric acid to set the pH.

In the cases in which the starting solvent used in electrolyte preparation, rather than water, is actually an acid, for example hydrochloric acid or sulfuric acid, addition of the boric acid, of the conductive salts and optionally of further additives to the electrolyte is preferably followed by setting of the desired pH by addition of a base, preferably of an alkali metal hydroxide, especially by addition of sodium hydroxide or potassium hydroxide, in solid form or as an aqueous solution.

The determination of the pH can be undertaken by methods which are common knowledge to those skilled in the art. Rough pH determinations can be undertaken merely with universal indicator paper, whereas a more exact setting of the pH can be undertaken by potentiometric means with the aid of a pH electrode.

In the case of an electrolyte (C) comprising chloride as anions, the pH is preferably set to a value in the range from 5.0 to 5.4.

In the case of an electrolyte (C) comprising sulfate as anions, the pH is preferably set to a value in the range from 2.0 to 3.0.

The cycling stability and also the lifetime of a rechargeable electrochemical zinc-oxygen cell are adversely affected by factors including the formation of zinc dendrites at the anode in the charging operation. It is known that the growth of dendrites can cause short circuits within an electrochemical cell. Homogeneous, dendrite-free deposition of the zinc on the anode therefore has a positive effect on the cycling stability of a rechargeable electrochemical zinc-oxygen cell. There are additives known from electroplating technology which promote homogeneous, very substantially dendrite-free metal deposition on a surface. These additives are especially surfactants and what are called brighteners, and some of these additives can be referred to both as a surfactant and as a brightener.

In a further embodiment of the present invention, in the inventive rechargeable electrochemical zinc-oxygen cell, the aqueous electrolyte (C) comprises at least one surfactant.

The surfactant may in principle be an nonionic or ionic surfactant. Preference is given to nonionic or anionic surfactants, especially nonionic surfactants. Examples of preferred nonionic surfactants are linear or branched alkyl ethoxylates. Examples of preferred anionic surfactants are alkyl ethoxylate sulfonates, alkyl ethoxylate sulfates, alkylphenol ethoxylate sulfonates or alkylphenol ethoxylate sulfates.

The concentration of the surfactant in the electrolyte (C) can be varied within a wide range. Preference is given to using the surfactant in a concentration of 0.1 to 10 g/l.

Commercially available suitable anionic surfactants are, for example, polyethylene glycol octyl (3-sulfopropyl) diether, potassium salt (CAS number 154906-10-2), polyethylene glycol alpha-alkyl omega-(3-sulfopropyl) diether, potassium salt (CAS number 119481-71-9) or polyethylene/propylene glycol (beta-naphthyl) (3-sulfopropyl) diether, potassium salt (CAS number 120478-49-1).

Commercially available suitable nonionic surfactants are, for example, octaethylene glycol octyl ether (CAS number 26468-86-0) or beta-naphthol ethoxylate (Lugalvan® BNO 12).

In a further embodiment of the present invention, in the inventive rechargeable electrochemical zinc-oxygen cell, the aqueous electrolyte (C) comprises at least one brightener, especially a brightener selected from the group consisting of alkali metal salts of naphthalenesulfonic acid condensates (Tamol® NN 8906), thiodiglycol ethoxylates and benzalacetone.

The present invention further provides for the use of an aqueous electrolyte comprising boric acid for production or for operation of rechargeable electrochemical zinc-oxygen cells. The further constituents of the boric acid-containing electrolyte and preferred embodiments thereof have been described above.

The inventive rechargeable electrochemical zinc-oxygen cell may further comprise, for separation of anode (A) and gas diffusion electrode (B), a separator which prevents a short circuit between anode (A) and gas diffusion electrode (B) but permits the migration of ions between the electrodes.

Suitable separators are polymer films, especially porous polymer films, which are unreactive toward the zinc of the anode, toward the reduction products formed at the cathode (B) in the discharging operation, and toward the constituents of the electrolyte in the inventive rechargeable electrochemical zinc-oxygen cells. Particularly suitable materials for separators are polyolefins, especially porous polyethylene films and porous polypropylene films.

Additionally suitable is glass fiber-reinforced paper or inorganic nonwovens, such as glass fiber nonwovens or ceramic nonwovens.

The separator used in the inventive zinc-oxygen cells is preferably an acid-resistant, inert material. In a preferred embodiment, polyolefins are used, especially porous polyethylene films and porous polypropylene films. The separator preferably has a thickness of 10 to 200 μm. Further suitable separators are other acid-resistant polymers or inorganic compounds known to those skilled in the art. The separator may, for example, be a sulfonated polytetrafluoroethylene, a doped polybenzimidazole, a polyether ketone or polysulfone.

In a preferred embodiment, the separator has a porosity of 30 to 80%, especially of 40 to 70%. The porosity is understood to mean the ratio of cavity volume to total volume.

Inventive rechargeable electrochemical zinc-oxygen cells comprise, as further components, electrical contacts which connect cathode (B) and anode (A) to one another. These electrical contacts are preferably established by introducing, in a manner known per se, the electrode layers of conductive and corrosion-resistant materials, preferably of carbon or nickel, which are connected to the corresponding electrodes. Further suitable compounds are copper alloys known to those skilled in the art, electrically conductive polymers, for example polyaniline, 3,4-polyethylenedioxythiophene polystyrenesulfonate (PEDOT/PSS) or polyacetylene. In a particularly preferred embodiment, a composite composed of carbon and polymer is used.

The inventive rechargeable electrochemical zinc-oxygen cells are installed into a suitable vessel for use. This vessel consists preferably of polymeric materials. It is provided with insulated contacts for the electrodes and has at least one orifice through which air or oxygen can enter or escape for operation of the cell.

Inventive rechargeable electrochemical zinc-oxygen cells exhibit a small decline in theoretical cell voltage and feature increased energy efficiency and good stability. More particularly, inventive rechargeable electrochemical zinc-oxygen cells are notable for improved cycling stability.

The present invention further provides for the use of inventive rechargeable electrochemical zinc-oxygen cells as described above in zinc-air batteries. The present invention further provides zinc-air batteries comprising at least one inventive rechargeable electrochemical zinc-oxygen cell as described above. The inventive rechargeable electrochemical zinc-oxygen cells can be combined with one another in inventive zinc-air batteries, for example in series connection or in parallel connection. Series connection is preferred.

The present invention further provides for the use of inventive rechargeable electrochemical zinc-oxygen cells as described above in automobiles, bicycles driven by electric motor, aircraft, ships, or especially in stationary energy stores.

The invention is illustrated by the examples which follow, but these do not restrict the invention.

Figures in percent (%) each relate to percent by weight (% by weight), unless explicitly stated otherwise.

### I. Construction of an Inventive Cell C.A and of a Noninventive Comparative Cell C-C.B

The inventive cell C.A and the noninventive cell C-C.B were each rechargeable electrochemical zinc-oxygen cells which each comprised an anode of metallic sheet Zn (commercially available, thickness: 1.0 mm), a cathode consisting of a gas diffusion electrode (GDL, commercially available from SGL Carbon) and a cathode active material (catalyst: MnO₂, commercially available from Alfa Aesar) and an aqueous electrolyte. The electrolyte E1 of the inventive cell C.A comprised 1.25% boric acid, while the electrolyte C-E2 of the noninventive comparative cell C-C.B did not comprise boric acid. Neither cell comprised a separator. The anode and cathode were arranged parallel to one another at a distance of 1.5 cm.

### I.1 Production of the Cathode

The MnO₂ catalyst was applied by means of screenprinting to a gas diffusion layer (GDL) of thickness 300 μm with a microporous carbon layer (MPL) and a PTFE (polytetrafluoroethylene) content of 30%, which had not been treated thermally prior to the coating operation. For this purpose, a mixture of 30 parts by weight of MnO₂, 50 parts by weight of conductive black (Ketjenblack® EC300J from AkzoNobel) and 20 parts by weight of an aqueous dispersion of polytetrafluoroethylene (60% by weight of PTFE in the dispersion) was produced by grinding. 4.4 g of this mixture consisting of MnO₂/carbon black/PTFE and water were mixed together with 6.0 g of isopropanol, 0.4 g of the dispersant EFKA®4585 (an acrylic block copolymer having an active content of about 50%) and 40 g of water with the aid of a homogenizer (Kinematica Polytron) at 10000 rpm for 2-3 min. A viscous (honey-like) mixture was produced as the ink. The ink was applied to the GDL in several layers by means of screenprinting, and each printing operation was followed by drying of the electrode at 80° C. for about 4 min and then lamination at 120° C. In total, about 0.45 mg MnO₂/cm² was applied to the GDL in this way.

### I.2 Electrolytes for the Inventive Cell C.A and the Noninventive Comparative Cell C-C.B

I.2.1 E.1 for cell C.A

The boric acid-containing electrolyte E.1 for the inventive cell C.A comprised: 1.25% boric acid, 0.25 mol/l ZnCl₂, 1.75 mol/l KCl, and as additives 0.1% Tamol® NN 8906 and 0.1% Plurafac® LF401 (nonionic surfactant); the pH was adjusted to 4 with hydrochloric acid. The conductivity of the electrolyte E.1 was 178 mS/cm.

### I.2.2 C-E.2 for Cell C-C.B

The non-boric acid-containing electrolyte C-E.2 of the noninventive cell C-C.B comprised: 0.25 mol/l ZnCl₂, 1.75 mol/l NH₄Cl, and as additives 0.1% Tamol® NN 8906 and 0.1% Plurafac® LF401 (nonionic surfactant); the pH was adjusted to pH 4 with hydrochloric acid. The conductivity of the electrolyte C-E.2 was 184 mS/cm.

Thus, both electrolytes have the same concentrations of Zn²⁺ ions and Cl⁻ ions, and also identical pH values and similar conductivities.

### II. Electrochemical Testing of the Cells C.A and C-C.B

To determine the activity of the catalyst and the stability thereof under electrochemical stress, the cells C.A and C-C.B were analyzed by means of cyclic voltammetry. 50 cycles were recorded with an advance rate of 100 mV/s. The start potential used was the open circuit potential; the reverse potentials were +0.8 and +2.0 V. For an identical active area, the current represents a measurement of the activity of the catalyst; a decrease in the current density from cycle to cycle shows degradation of the catalyst and hence lack of cycling stability of the cell.

### III. Experimental Results

The experimental data reproduced in table 1 show that the noninventive cell C-C.B had a higher current at the start of the measurements, i.e. the current at +2 V rose during the first 10 cycles, but a significant decrease in the current is observed overall with increasing number of cycles. This corresponds to a poor cycling stability of the rechargeable Zn-oxygen cell. The inventive cell C.A with boric acid in the electrolyte is more stable and shows virtually no decrease in the current at +2 V with increasing number of cycles, and a significantly reduced decrease in the current density at 0.8 V compared to the cell C-C.B. After a number of cycles (35 cycles at 2 V; at 0.8 V), the current density of the inventive boric acid-containing cell C.A was greater than that of the comparative cell C-C.B. The experimental results show that the addition of boric acid has a positive effect on the cycling stability of the cell.

TABLE 1
Test results of the above-described inventive and noninventive
electrochemical cells. The table comprises current values (in mA)
at the reverse potentials (+2.0 V and +0.8 V).

| Example | |
|---|---|
| | Noninventive |
| | comparative cell |
| Inventive cell C.A | V-C.B |

Potential

| | +0.8 V | +2.0 V | +0.8 V | +2.0 V |
|---|---|---|---|---|
| 2nd cycle | −59.1 mA | 60.9 mA | −87.6 mA | 83.6 mA |
| 5th cycle | −56.9 mA | 62.6 mA | −80.1 mA | 89.3 mA |
| 10th cycle | −55.5 mA | 63.5 mA | −72.7 mA | 90.4 mA |
| 15th cycle | −51.8 mA | 62.8 mA | −67.8 mA | 85.7 mA |
| 20th cycle | −53.5 mA | 64.1 mA | −59.5 mA | 80.5 mA |
| 25th cycle | −53.6 mA | 63.8 mA | −58.7 mA | 74.2 mA |
| 30th cycle | −53.1 mA | 63.6 mA | −55.5 mA | 66.1 mA |
| 35th cycle | −49.4 mA | 62.4 mA | −50.8 mA | 62.3 mA |
| 40th cycle | −51.0 mA | 62.9 mA | −50.9 mA | 59.3 mA |
| 45th cycle | −51.1 mA | 62.4 mA | −49.0 mA | 56.3 mA |
| 50th cycle | −50.2 mA | 61.3 mA | −46.8 mA | 55.9 mA |

### IV. Study of Zinc Deposition in Various Electrolytes:

In order to simulate the deposition behavior of zinc in the course of charging of the Zn/air battery, depositions were conducted in what is known as the Hull cell. In this case, it is possible to illustrate the morphology and optics of electrolytic metal depositions over a wide current density range in one experiment.

For this purpose, steel sheets were pickled with 15% hydrochloric acid, rinsed, electrolytically degreased and deoxidized with 10% sulfuric acid. The Zn deposition was effected to DIN 50957 in a standard Hull cell (for example from McGean-Rohco) with 250 ml of electrolyte at cell current 1 A for 10 min. The anodes used (in relation to the metal deposition) were pure zinc electrodes (for example from AMPERE).

The boric acid-containing electrolyte E.3 comprised:

1.25% boric acid, 0.25 mol/l ZnCl₂ and 1.75 mol/l KCl; the pH was adjusted to 4 with hydrochloric acid.

The non-boric acid-containing electrolyte C-E.4 comprised:

0.25 mol/l ZnCl₂ and 1.75 mol/l NH₄Cl; the pH value was adjusted to pH 4 with hydrochloric acid.

The two electrolytes E.3 and C-E.4 thus had the same Zn content, chloride content and pH. They differ merely in the nature of the buffer substance.

The boric acid-containing electrolyte E.5 comprised:

1.25% boric acid, 0.25 mol/l ZnCl₂, 1.75 mol/l KCl, and as additive 0.1% Tamol® NN 8906 (dispersants) and 0.2% Plurafac® LF401 (nonionic surfactant as wetting agent); the pH was adjusted to pH 4 with hydrochloric acid.

The non-boric acid-containing electrolyte C-E.6 comprised:

0.25 mol/l ZnCl₂, 1.75 mol/l NH₄Cl, and as additive 0.1% Tamol® NN 8906 (dispersants) and 0.2% Plurafac® LF401 (nonionic surfactant as wetting agent); the pH was adjusted to pH 4 with hydrochloric acid.

### Result:

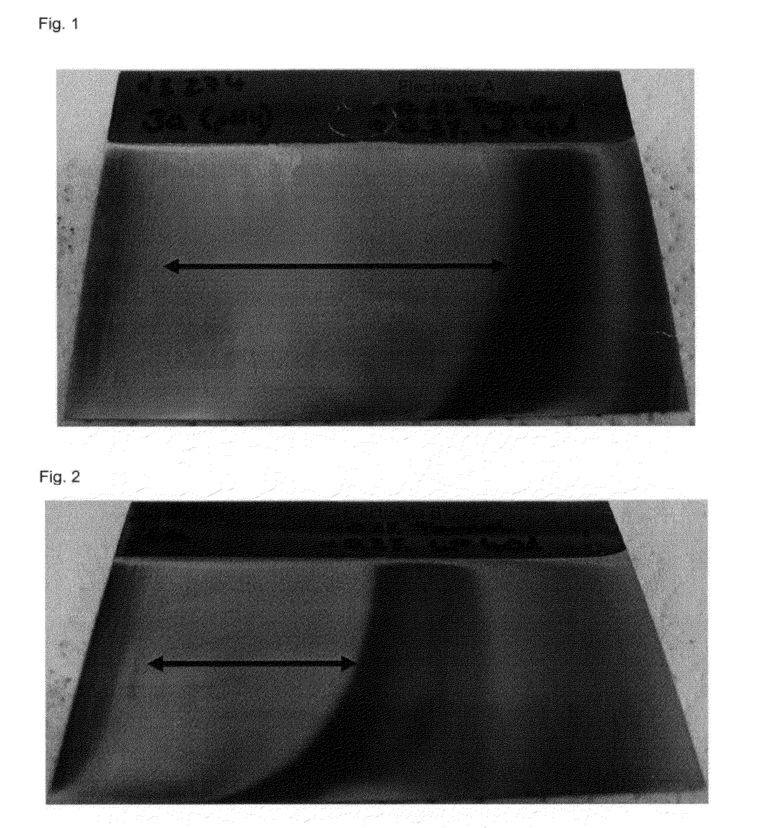

In the high current density range, the deposition from the boric acid-containing electrolytes E.3 and E.5 (FIG. 1) has a much lower level of amorphous structures than that from the ammonium-containing electrolytes C-E.4 and V-E-6 (FIG. 2); more particularly, no dendrites and a layer with good adhesion on the steel sheet. Moreover, the deposition is more homogenous at lower current densities.

The current density range applicable for the operation of a Zn/air battery is greater for the boric acid-containing electrolyte E.5 (FIG. 1) than for the ammonium-containing electrolyte C-E-6 (FIG. 2).

Electrolyte E.3: from 2.5 to 0.25 A/dm²

Electrolyte C-E.4: from 2.0 to 0.3 A/dm²

The addition of additives such as wetting agents, e.g. 0.2% Plurafac LF 401, and dispersants, e.g. 0.1% Tamol NN 8906, enhances this effect.

Electrolyte E.5: good deposition from 5 to 0.7 A/dm²

Electrolyte C-E.6: good deposition from 4 to 1.8 A/dm²

1. A rechargeable electrochemical zinc-oxygen cell comprising
A) an anode comprising metallic zinc,
B) a gas diffusion electrode comprising
(B1) a cathode active material, and
(B2) optionally a solid medium through which gas can diffuse, and
C) an aqueous electrolyte comprising boric acid.

2. The rechargeable electrochemical zinc-oxygen cell according to claim 1, wherein the cathode active material comprises at least one catalyst selected from the group consisting of La₂O₃, WC, Ce(WO₄)₃, FeAgMo₂O₈, Fe₂(Wo₄)₃, Mn₃O₄, Mn₂O₃, MnO₂, KMnO₄, MnSO₄, SnO₂, Fe₂O₃, Co₃O₄, CoO, IrO₂, Ag₂O, Co, Ni, Fe, Pt, Pd, Ir, Pt_{4.5}Ru₄Ir_{0.5}, Ag, Pd—W, a spinel and a perovskite.

3. The rechargeable electrochemical zinc-oxygen cell according to claim 1, wherein the aqueous electrolyte comprises at least one conductive salt selected from the group consisting of an alkali metal halide, an alkali metal sulfate, an alkali metal methanesulfonate, a zinc halide, zinc sulfate and zinc methanesulfonate.

4. The rechargeable electrochemical zinc-oxygen cell according to claim 1, wherein the aqueous electrolyte has a pH in a range from 0 to 7.

5. The rechargeable electrochemical zinc-oxygen cell according to claim 1, wherein the aqueous electrolyte comprises a surfactant.

6. The rechargeable electrochemical zinc-oxygen cell according to claim 1, wherein the aqueous electrolyte comprises at least one brightener selected from the group consisting of an alkali metal salt of a naphthalenesulfonic acid condensate, a thiodiglycol ethoxylate and benzalacetone.

7. (canceled)

8. A zinc-air battery comprising the rechargeable electrochemical zinc-oxygen cell according to claim 1.

9. An automobile, bicycle driven by an electric motor, aircraft, ship or stationary energy store comprising the rechargeable electrochemical zinc-oxygen cell according to claim 1.

10. A rechargeable electrochemical zinc-oxygen cell comprising an aqueous electrolyte comprising boric acid.

11. The rechargeable electrochemical zinc-oxygen cell according to claim 1, wherein the gas diffusion electrode comprises the solid medium.

12. The rechargeable electrochemical zinc-oxygen cell according to claim 2, wherein the aqueous electrolyte comprises at least one conductive salt selected from the group consisting of an alkali metal halide, an alkali metal sulfate, an alkali metal methanesulfonate, a zinc halide, zinc sulfate and zinc methanesulfonate.

13. The rechargeable electrochemical zinc-oxygen cell according to claim 2, wherein the aqueous electrolyte has a pH in a range from 0 to 7.

14. The rechargeable electrochemical zinc-oxygen cell according to claim 3, wherein the aqueous electrolyte has a pH in a range from 0 to 7.

15. The rechargeable electrochemical zinc-oxygen cell according to claim 12, wherein the aqueous electrolyte has a pH in a range from 0 to 7.

16. The rechargeable electrochemical zinc-oxygen cell according to claim 2, wherein the aqueous electrolyte comprises a surfactant.

17. The rechargeable electrochemical zinc-oxygen cell according to claim 3, wherein the aqueous electrolyte comprises a surfactant.

18. The rechargeable electrochemical zinc-oxygen cell according to claim 4, wherein the aqueous electrolyte comprises a surfactant.

19. The rechargeable electrochemical zinc-oxygen cell according to claim 12, wherein the aqueous electrolyte comprises a surfactant.

20. The rechargeable electrochemical zinc-oxygen cell according to claim 13, wherein the aqueous electrolyte comprises a surfactant.

21. The rechargeable electrochemical zinc-oxygen cell according to claim 15, wherein the aqueous electrolyte comprises a surfactant.
